(19) United States
(12) Patent Application Publication
(10) Pub. No.: US 2024/0377294 A1
(43) Pub. Date: Nov. 14, 2024

(54) Slide Stainer Device with Automated Reagent Filtering

(71) Applicant: Yolanda Richardson, Anderson, SC (US)

(72) Inventor: Yolanda Richardson, Anderson, SC (US)

(21) Appl. No.: 18/616,537

(22) Filed: Mar. 26, 2024

Related U.S. Application Data
(60) Provisional application No. 63/500,744, filed on May 8, 2023.

(51) Int. Cl. G01N 1/31

(52) U.S. Cl. CPC G01N 1/31

(57) ABSTRACT

An automated slide stainer system equipped with an innovative automated reagent filtering system is disclosed. The system comprises a housing accommodating distinct processing stations (buckets) for diverse staining reagents. A controlling system with touch buttons and a display device manages the staining process. Each station or bucket features a plastic tubing system with first and second openings, enabling automated reagent outflow, filtration using Millipore filters, and reintroduction of filtered reagent. The controlling system initiates outflow and reintroduction of the reagent using a mechanical device such as a pump wherein the reagent flows through a plastic tubing and filtered using filters disposed inside the tubing.

### CROSS-REFERENCE TO RELATED APPLICATION

The present application claims priority to, and the benefit of, U.S. Provisional Application No. 63/500,744, which was filed on May 8, 2023 and is incorporated herein by reference in its entirety.

### FIELD OF THE INVENTION

The present invention generally relates to the field of slide stainer devices used for treating biological specimens. More specifically, the present invention relates to a novel slide stainer device with an automated reagent filtering system. The device includes a plurality of staining buckets, each staining bucket has an attached plastic tubing. The plastic tubing includes Millipore filters for filtering the reagent passing therethrough. The reagent is reintroduced in the bucket after filtering. A control system operates a pump to automatically flow out and return the reagent into the bucket. Accordingly, the present disclosure makes specific reference thereto. Nonetheless, it is to be appreciated that aspects of the present invention are also equally applicable to other like applications, devices, and methods of manufacture.

### BACKGROUND

By way of background, a slide stainer is a laboratory instrument used for various tasks, especially when scientists want to add colors to their samples to study the samples better under a microscope. More specifically, the slide stainer is used to apply dyes to microscope slides to make the structures of cells and tissues visible. Slide stainers are commonly used in histology, cytopathology, microbiology, pathology, and more. The colors or dyes commonly known as staining reagents are used for highlighting samples.

Once the staining process is complete, the reagents are required to be removed from the samples. Traditionally, lab workers manually remove the staining reagents from the slide stainer. The process generally involves pouring the reagent out of the corresponding stain bucket into a specific container or beaker. The manual process of reagent removal and pouring is laborious, time-consuming, and can slow down the overall productivity of the lab. The staining buckets are also required to be cleaned to prevent color contamination. Further, the reagents are also manually filtered to remove traces of used samples.

For reuse, the staining reagents are poured back from beakers into staining buckets. This process involves pouring the reagents from the containers back into the buckets and may be messy and may even pose a hazard, due to splashes reaching the eyes and causing harm. The manual process of filtering and removing reagents is complex, time consuming, and challenging. People desire an improved system that automates the removal of staining reagents from the slide stainer.

Therefore, there exists a long felt need in the art for a slide stainer with an automated filtration system. Additionally, there is a long felt need in the art for an improved filtration system for filtering and removing stain reagents from an automated slide stainer. Moreover, there is a long felt need in the art for an automated slide stainer with automated filtration for use in laboratories. Further, there is a long felt need in the art for a slide stainer with automated filtration system that includes plastic tubing for filtering stain reagents. Furthermore, there is a long felt need in the art for an improved automated slide stainer that eliminates the manual process of filtering reagents. Finally, there is a long felt need in the art for a slide stainer with automated filtration system that increases productivity, saves time, and decreases the risk of splash hazard of manual filtration process of stain reagents used in slide stainer devices.

The subject matter disclosed and claimed herein, in one embodiment thereof, comprises an automated slide stainer device with an integrated automated reagent filtering system. The slide stainer device automatically filters used reagent using the filtering system. The device includes a plurality of processing stations or buckets for staining samples. A controlling system is disposed on a front surface of the device and includes a display device for providing status indications of the processing buckets, and a plurality of touch buttons for controlling system operations. Each processing bucket has a first opening for automated outflow of a staining reagent therefrom and a second opening located above the first opening for reintroduction of filtered reagent, wherein the filtration of the used reagent of the bucket is performed by Millipore filter disposed in a plastic tubing. The outflow and inflow of the reagent is facilitated by a pump which is activated by the controlling system upon completion of the staining operation of the bucket.

In this manner, the automated slide stainer device with an integrated automated reagent filtering system of the present invention accomplishes all of the forgoing objectives and provides users with an automated stain reagent filtration system for use in laboratories. The reagent is automatically filtered using Millipore filters when the reagent is automatically removed into a tubing containing filters by a pump upon action of the control system. The device increases productivity and saves time by obviating the need to remove multiple stain buckets in manually filtering reagents.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an automated slide stainer device equipped with an automated reagent filtering system. The slide stainer device comprising a housing for accommodating a plurality of processing stations or buckets. Each processing bucket is configured to hold a staining reagent for staining specimens or samples. A controlling system is disposed on a front surface of the device and includes a display device for providing status indications of the processing buckets, and a plurality of touch buttons for controlling system operations. Each processing bucket has a first opening for automated outflow of a staining reagent therefrom and a second opening located above the first opening for reintroduction of filtered reagent, wherein the filtration of the used reagent of the bucket is performed by Millipore filter disposed in a plastic tubing.

In yet another embodiment, an automated slide stainer device with an integrated automated reagent filtering system is disclosed. The automated reagent filtering system is used to automatically filter a used reagent and includes a plurality of plastic tubes, each tube is connected to a corresponding reagent bucket and includes a first portion extending from a first opening of the bucket for outflow of reagent, a filter portion for housing a filter element for capturing particles in the reagent, and a second portion for flowing the filtered reagent back into the processing bucket for reuse. A controlling system of the device automatically initiates outflow of reagent from the bucket upon completion of the staining process using said bucket and automatically reintroduces the filtered reagent back into said bucket.

In a further embodiment, an automated filtering system for stain reagents in a slide stainer apparatus is disclosed. The automated filtering system includes a plurality of plastic tubes, each plastic tube being independently and separately connected to a processing bucket within said slide stainer apparatus, wherein said plastic tubes enable automated filtering of stain reagents contained in corresponding processing buckets, each plastic tube forms an individual closed filtering loop dedicated to a reagent stored in the respective processing bucket and includes a first portion extending from a first opening of a processing bucket for automatic outflow of the reagent, a filter portion housing Millipore filters designed to filter the reagent by capturing any materials present in the reagent from previous staining processes, a second portion directing filtered reagent back from the Millipore filters to the same processing bucket. A pump operated by the control system automatically creates a pressure to outflow the reagent and direct the reagent back from the plastic tube.

In another aspect of the present invention, a method for automated filtering of stain reagents in a slide stainer device is described. The method comprising the steps of providing a plurality of processing buckets within said slide stainer apparatus, wherein each processing bucket contains a stain reagent for staining specimens, connecting an independent and separate plastic tubing to each processing bucket among the plurality of processing buckets, initiating automatic outflow of the stain reagent from a processing bucket to the connected plastic tubing, passing the outflowing stain reagent through a filter portion of the plastic tubing, the filter portion accommodating Millipore filters to capture any materials present in the stain reagent from previous staining processes, directing the filtered stain reagent back to the same processing bucket.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of an automated slide stainer with automated reagent filtering system of the present invention in accordance with the disclosed architecture;

FIG. 2 illustrates a rear perspective view of the automated slide stainer with automated reagent filtering system of the present invention in accordance with the disclosed architecture;

FIG. 3 illustrates an isolated view of the Millipore filter used in the automated slide stainer with automated reagent filtering system of the present invention in accordance with the disclosed structure;

FIG. 4 illustrates a functional block diagram depicting the use of a mechanical device for flowing the staining reagent out from and back into a bucket for filtering in accordance with the disclosed architecture; and

FIG. 5 illustrates a flow diagram depicting a process of automated stain filtration by the automated slide stainer device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a slide stainer with an automated filtration system. Additionally, there is a long felt need in the art for an improved filtration system for filtering and removing stain reagents from an automated slide stainer. Moreover, there is a long felt need in the art for an automated slide stainer with automated filtration for use in laboratories. Further, there is a long felt need in the art for a slide stainer with automated filtration system that includes plastic tubing for filtering stain reagents. Furthermore, there is a long felt need in the art for an improved automated slide stainer that eliminates the manual process of filtering reagents. Finally, there is a long felt need in the art for a slide stainer with automated filtration system that increases productivity, saves time, and decreases the risk of splash hazard of manual filtration process of stain reagents used in slide stainer devices.

The present invention, in one exemplary embodiment, is an automated filtering system for stain reagents in a slide stainer apparatus. The automated filtering system includes a plurality of plastic tubes, each plastic tube being independently and separately connected to a processing bucket within said slide stainer apparatus, wherein said plastic tubes enable automated filtering of stain reagents contained in corresponding processing buckets, each plastic tube forms an individual closed filtering loop dedicated to a reagent stored in the respective processing bucket and includes a first portion extending from a first opening of a processing bucket for automatic outflow of the reagent, a filter portion housing Millipore filters designed to filter the reagent by capturing any materials present in the reagent from previous staining processes, a second portion directing filtered reagent back from the Millipore filters to the same processing bucket. A pump operated by the control system automatically creates a pressure to outflow the reagent and direct the reagent back from the plastic tube. The plastic tubing may be replaced after each 100 slides to maintain cleanliness and the integrity of the system. Weekly cleaning can be done by flushing the plastic tubing with a cleaning agent.

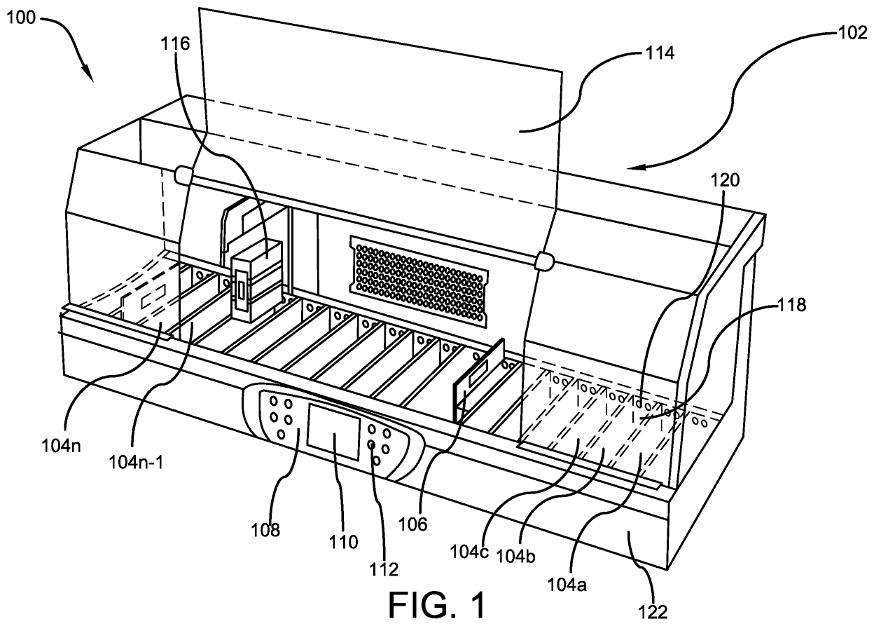

Referring initially to the drawings, FIG. 1 illustrates a front perspective view of automated slide stainer with automated reagent filtering system of the present invention in accordance with the disclosed architecture. The automated slide stainer equipped with automated reagent filtering system 100 of the present invention is designed as an improved slide stainer system to prevent cross contamination during the process of staining samples for microscopic analysis. The slide stainer device 100 provides automated filtering of stain reagents without manually removing the stain buckets. More specifically, the automated slide stainer device 100 includes a housing 102 for storing a plurality of processing stations or buckets 104a-n (hereinafter referred to as 104). One or more slides 106 which contains specimens or samples are moved through a series of stations 104. Each processing station 104 includes a different staining reagent for staining the specimen or sample.

The automated slide stainer device 100 includes a controlling system 108 disposed on the front surface 122 of the device 100 for controlling the staining process. The controlling system 108 includes a display device 110 for displaying status of different processing buckets 104 indicating whether the buckets are available for staining. A plurality of touch buttons 112 are provided for controlling operation of the automated slide stainer device 100. A pivoting lid 114 provides access to the buckets 104 and slides 106 for performing staining process of the specimen or sample.

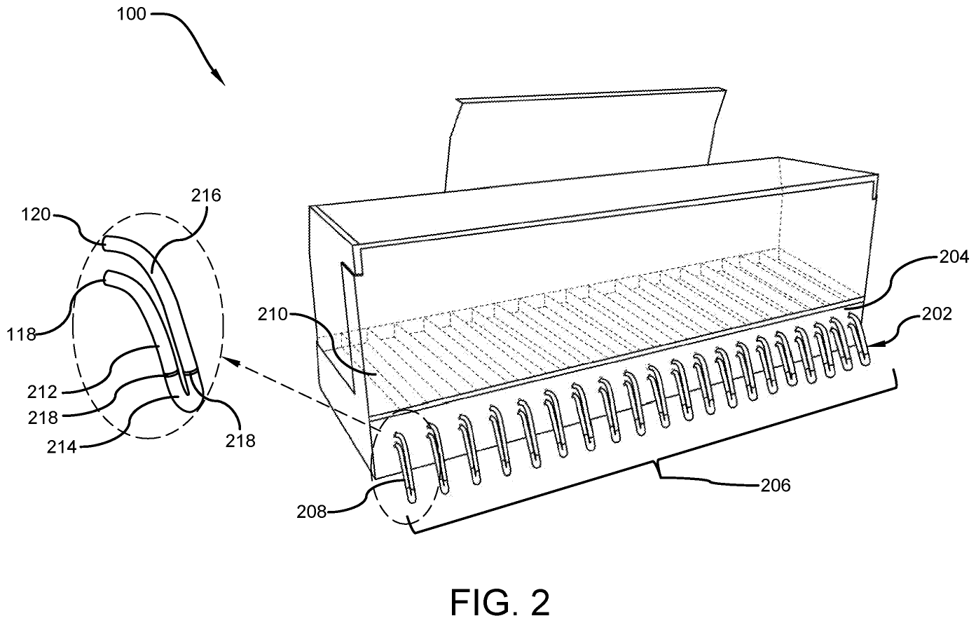

A loading tray 116 is used for loading a slide for staining using reagents stored in the buckets 104. The loading tray 116 releases the slide automatically into an available bucket 104 by the controlling system 108. Each staining bucket 104 of the device 100 is specially designed for automatically filtering of the staining reagent stored therein. As illustrated, each bucket 104 includes a first opening 118 for automatically flowing the reagent out of the bucket through a connected plastic tubing for filtering as illustrated in FIG. 2. A second opening 120 is disposed above the first opening 118 for allowing filtered reagent back into the bucket for reuse of the reagent. It will be apparent to a person skilled in the art that although the openings 118, 120 are described for only one bucket, but all the processing buckets 104 of the automated slide stainer device 100 have similar pair of openings for automated filtering of used reagents.

The control system 108 of the device 100 automatically activates flowing of the reagent out of a bucket when staining process using the bucket is completed. Similarly, the control system 108 automatically flows back the filtered reagent to the bucket using a motor or pump as described later in the disclosure.

FIG. 2 illustrates a rear perspective view of the automated slide stainer with automated reagent filtering system of the present invention in accordance with the disclosed architecture. The automated filtering system 202 is connected to the rear surface 204 of the slide stainer device 100. The automated filtering system 202 includes a plurality of plastic tubes 206 wherein an independent and separate plastic tubing is connected to each processing bucket 104. The plastic tubes 206 allow automated filtering of stain reagent of the corresponding bucket. More specifically, as an example, an individual plastic tubing 208 is coupled to the openings 118, 120 of a bucket 210 (shown as an example from the buckets 104). The plastic tubing 206 forms a closed filtering loop for reagent stored in the corresponding bucket 210. Similarly, each plastic tubing of the plurality of plastic tubes 206 form individual filtering system for automated filtering of reagents stored in the buckets.

The plastic tubing 208 includes a first portion 212 extending from the first opening 118 for automatically flowing out the reagent from the bucket 210. The plastic tubing 208 includes a filter portion 214 including Millipore filters 218 for filtering the reagent by capturing any material present in the reagent during earlier staining process. A second portion 216 of the plastic tubing 208 flows back the filtered reagent from the Millipore filter 218 to the bucket 210. The first portion 212, the filtering portion 214, and the second portion 216 are in fluid communication.

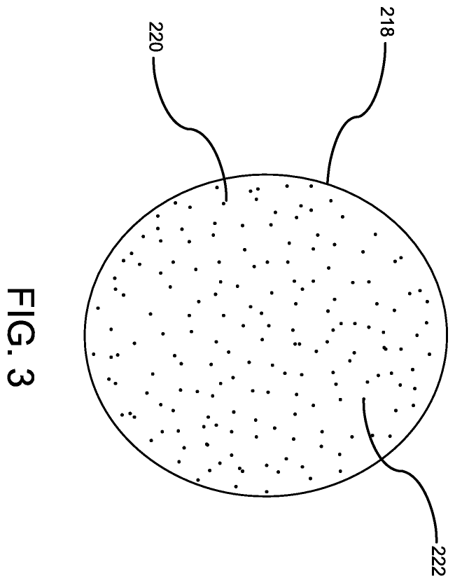

Referring to FIG. 3, the Millipore filter 218 is made of a thin membrane 220 having a plurality of pores 222. The pores 222 are of a consistent size and can have a diameter from about 5 micrometers to about 100 micrometers. The membrane 220 functions as a physical barrier, allowing only particles smaller than the pore size to pass through while blocking larger particles. It will be apparent to a person skilled in the art that the Millipore filter 218 can be used for filtering reagents used for cell cultures, purification of biomolecules, concentrate particles, contaminants, and more. The Millipore filter 218 is preferably made of mixed cellulose esters (MCE) membrane, is hydrophilic, and is of any color. Further, the plastic tubing can be removed to replace the filter with a new filter after usage for a period.

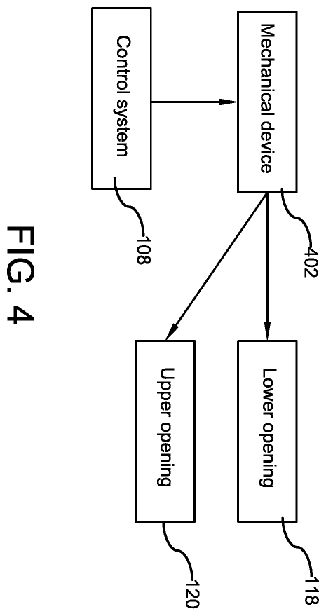

FIG. 4 illustrates a functional block diagram depicting the use of a mechanical device for flowing the staining reagent out from and back into a bucket for filtering in accordance with the disclosed architecture. As illustrated, a mechanical device 402, preferably in the form of a pump is integrated into the stainer device 100 for automatically taking the stain reagent out of a bucket and returning the reagent back to the bucket after a staining process is completed. The mechanical device 402 is coupled to the control system 108, wherein the control system 108 automatically activates the mechanical device 402 for a particular bucket, when the staining process of the bucket is determined to be completed. The mechanical device 402 can be common for all the buckets of the device 100 or can be separately configured for individual buckets as well in some embodiments of the present invention.

More specifically, the mechanical device 402 creates a pressure difference to flow the reagent out from the opening 118 of the bucket and flow back in through the opening 120. The filtering of the reagent is done by the Millipore filter 218 and the mechanical device 402 helps in reuse of reagent for staining purposes.

Each plastic tubing included in the automated slide stainer 100 filters the reagent using the same process wherein the mechanical device 402 flows out the staining reagent through the first portion 212 and returns via the second portion 216 of the plastic tubing. Individual plastic tubing is removable, replaceable and is made of medical grade plastic.

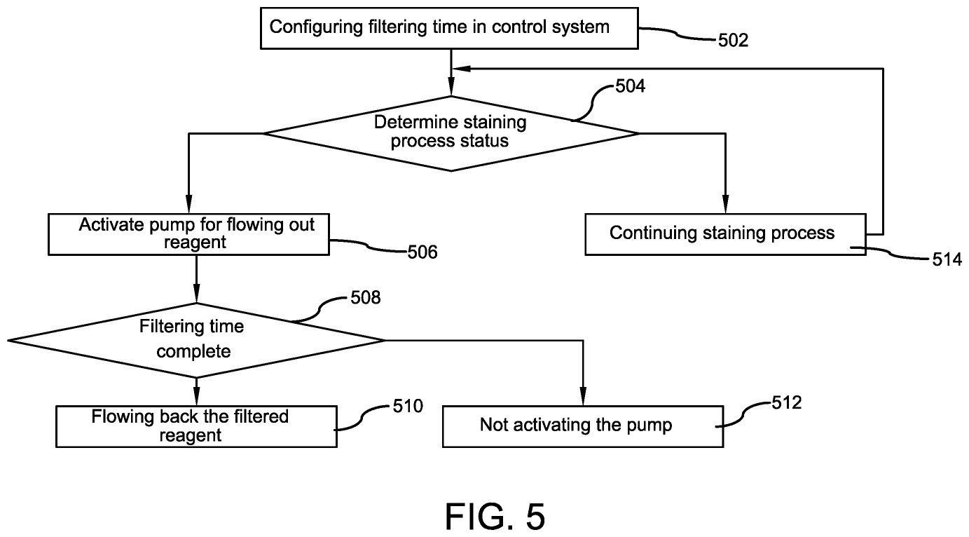

FIG. 5 illustrates a flow diagram depicting a process of automated stain filtration by the automated slide stainer device of the present invention in accordance with the disclosed architecture. The device 100 automates the process of filtering stain reagents used therein by providing each processing bucket, an independent dedicated plastic tubing loop that allows the reagent to flow out of the bucket, filtered through Millipore filters, and then flow back into the same bucket. During the filtering process, initially, a filtering time is configured in the control system 108 of the device (Step 502). The configuration can be done using the touch buttons 112 and the display device 110. The filtering time denotes the time required for filtering reagent by the filtering loop 214. The filtering time is used by the control system 108 for automatically activating and deactivating the mechanical device/pump 402 for flowing out and flowing back the reagent.

In the next step 504, the status of the staining process is determined by the control system 108. In one embodiment, the status can be determined using the presence of a slide in a bucket. In case the staining process is determined to be complete, then in step 506, the pump 402 is automatically activated by the control system 108 for flowing out the used reagent for filtration via the opening 118. The pump 402 is activated to complete remove the reagent from the bucket.

Then, in step 508, completion of the filtering time is checked by the control system 108 and in case the filtering time is complete, the reagent flows back into the bucket through the opening 120. In case the filtering time is not complete, then, in the present embodiment, in step 512, the pump is not activated and reagent is not returned to the bucket.

It should be noted that when the staining process of a bucket is activated, then, the staining process is continued and the pump 402 is not activated as in step 514 and the control system 108 continues to check the status of staining process of one or more buckets.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “automated slide stainer with automated reagent filtering system”, “automated slide stainer device”, “slide stainer device”, and “device” are interchangeable and refer to the automated slide stainer device 100 with equipped with automated reagent filtering system 202 of the present invention.

Notwithstanding the forgoing, the automated slide stainer device 100 with equipped with automated reagent filtering system 202 of the present invention can be of any suitable size and configuration as is known in the art without affecting the overall concept of the invention, provided that it accomplishes the above stated objectives. One of ordinary skill in the art will appreciate that the automated slide stainer device 100 with equipped with automated reagent filtering system 202 as shown in the FIGS. 1-3 are for illustrative purposes only, and that many other sizes and shapes of the automated slide stainer device 100 with equipped with automated reagent filtering system 202 are well within the scope of the present disclosure. Although the dimensions of the automated slide stainer device 100 with equipped with automated reagent filtering system 202 are important design parameters for user convenience, the automated slide stainer device 100 with equipped with automated reagent filtering system 202 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim

What is claimed is:

1. An automated slide stainer and reagent filtering system comprising:
a slide stainer device having a housing, a pivoting lid, a controlling system, and a reagent filtering system for filtering of stain reagents;
wherein said reagent filtering system is automatic;
wherein said housing storing a plurality of processing stations for moving one or more slides through said plurality of processing stations;
wherein each of said one or more slides including a specimen thereon;
wherein said controlling system having a series of controls and a display for controlling a staining process; and
further wherein said display displaying a status of said plurality of processing stations for indicating availability of one or more of said plurality of processing stations.

2. The automated slide stainer and reagent filtering system of claim 1, wherein said controlling system having a plurality of touch buttons for controlling operation of said slide stainer device.

3. The automated slide stainer and reagent filtering system of claim 2, wherein said pivoting lid providing access to said plurality of processing stations and to said one or more slides.

4. The automated slide stainer and reagent filtering system of claim 3, wherein each of said plurality of processing stations having a different staining reagent for staining said specimen.

5. The automated slide stainer and reagent filtering system of claim 4, wherein said one or more slides having a loading tray for loading and staining said one or more slides using a staining reagent.

6. The automated slide stainer and reagent filtering system of claim 5, wherein said loading tray releasing said one or more slides automatically into an available said one or more of said processing stations.

7. The automated slide stainer and reagent filtering system of claim 1, wherein each of said plurality of processing stations having a first opening and a filtering tube for automatic flowing of said reagent out of each of said plurality of processing stations and a second opening for automatic flowing of said reagent into each of said plurality of processing stations for reuse of said reagent.

8. The automated slide stainer and reagent filtering system of claim 7, wherein said second opening is positioned above said first opening for forming a closed filtering loop with said filtering tube.

9. The automated slide stainer and reagent filtering system of claim 8, wherein said automatic flowing of said reagent having a pump.

10. The automated slide stainer and reagent filtering system of claim 9, wherein said filtering tube having a first portion extending from said first opening for automatic flowing out said reagent, a filtering portion, and a second portion extending from said second opening for automatic flowing in said reagent.

11. The automated slide stainer and reagent filtering system of claim 10, wherein said filtering portion is in fluid communication between said first portion and said second portion.

12. The automated slide stainer and reagent filtering system of claim 11, wherein said filtering portion having a first Millipore filter at a first end and a second Millipore filter at a second end.

13. The automated slide stainer and reagent filtering system of claim 12, wherein each of said first Millipore filter and said second Millipore filter having a membrane including a plurality of pores, and further wherein said pores having a diameter from 5 micrometers to 100 micrometers.

14. The automated slide stainer and reagent filtering system of claim 13, wherein said membrane is a hydrophilic mixed cellulose esters (MCE) membrane.

15. A slide stainer and reagent filtering system comprising:
a slide stainer device having a housing, a pivoting lid, a controlling system, and a reagent filtering system for filtering of stain reagents;
wherein said housing storing a plurality of processing stations for moving one or more slides through said plurality of processing stations;
wherein each of said one or more slides including a specimen thereon;
wherein said controlling system having a series of controls and a display for controlling a staining process;
wherein each of said plurality of processing stations having a first opening and a filtering tube for flowing of said reagent out of each of said plurality of processing stations and a second opening for flowing of said reagent into each of said plurality of processing stations for reuse of said reagent;
wherein said filtering tube having a first portion extending from said first opening for flowing out said reagent, a filtering portion, and a second portion extending from said second opening for flowing in said reagent; and
further wherein said filtering portion is in fluid communication between said first portion and said second portion.

16. The slide stainer and reagent filtering system of claim 15, wherein said pivoting lid providing access to said plurality of processing stations and to said one or more slides.

17. The slide stainer and reagent filtering system of claim 15, wherein said loading tray releasing said one or more slides automatically into an available said one or more of said processing stations.

18. An slide stainer and reagent filtering system comprising:
a slide stainer device having a housing, a pivoting lid, a controlling system, and a reagent filtering system for filtering of stain reagents;
wherein said housing storing a plurality of processing stations for moving one or more slides through said plurality of processing stations;
wherein each of said one or more slides including a specimen thereon;
wherein said controlling system having a series of controls and a display for controlling a staining process;
wherein each of said plurality of processing stations having a first opening and a filtering tube for flowing of said reagent out of each of said plurality of processing stations and a second opening for flowing of said reagent into each of said plurality of processing stations for reuse of said reagent;
wherein said filtering tube having a first portion extending from said first opening for flowing out said reagent, a filtering portion, and a second portion extending from said second opening for flowing in said reagent;
wherein said filtering portion is in fluid communication between said first portion and said second portion; and
further wherein said filtering portion having a first Millipore filter at a first end and a second Millipore filter at a second end.

19. The slide stainer and reagent filtering system of claim 18, wherein each of said first Millipore filter and said second Millipore filter having a membrane including a plurality of pores, and further wherein said pores having a diameter from 5 micrometers to 100 micrometers.

20. The slide stainer and reagent filtering system of claim 19, wherein said membrane is a hydrophilic mixed cellulose esters (MCE) membrane.
